(19) United States
(12) Patent Application Publication
(10) Pub. No.: US 2023/0380380 A1
(43) Pub. Date: Nov. 30, 2023

(54) UNIVERSAL DRINKER BASE

(71) Applicant: Maximilian Lee, Terra Bella, CA (US)

(72) Inventor: Maximilian Lee, Terra Bella, CA (US)

(21) Appl. No.: 17/804,149

(22) Filed: May 26, 2022

(51) Int. Cl. A01K 7/00; A01K 39/02; B33Y 80/00

(52) U.S. Cl. CPC A01K 7/00; A01K 39/02; B33Y 80/00

(57) ABSTRACT

A drinker base for supplying water for animals is disclosed with a substantially annular outer chamber, a substantially annular middle chamber, a substantially annular inner chamber, a first set of threads for accepting a container device, the first set of threads disposed on an outer surface of the substantially annular middle chamber, a second set of threads disposed on an inner surface of the substantially annular middle chamber, a third set of threads disposed on an inner surface of the substantially annular inner chamber, a first port configured to transfer water between the substantially annular inner chamber to the substantially annular middle chamber, and a second port configured to transfer water between the substantially annular middle chamber substantially annular middle chamber to the substantially annular outer chamber.

### BACKGROUND OF THE INVENTION

### Technical Field

This invention relates to drinker bases. In particular, the invention relates to a drinker base that accepts multiple types of containers that carry liquids.

Drinker bases are known in the art. Drinker bases function based on gravity discharge of fluid restrained by vacuum force inside the water reservoir. In other words, the water will flow down through the hole at the lower portion of the water reservoir, until the water level rises above the discharging hole and the vacuum force inside the water reservoir is created. As animals drink the water and the water level goes below the discharging hole, air is sucked into the water reservoir allowing water to discharge again until the water level rises above the discharging hole and vacuum force is created again inside the water reservoir. This process repeats until the water in the water reservoir is depleted.

U.S. Pat. No. 1,069,943 describes a device for feeding poultry.

U.S. Pat. No. 1,565,117 describes a gravity-fed feeder.

However, none of the known art discloses a drinker base with multiple chambers to allow the use of different sized water containers in the same base, which then requires the use of multiple sized drinker bases, adding to expense and storage area. Therefore, a need exists for a universal drinker base that can accommodate different water containers.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

An embodiment of the disclosure is a drinker base for supplying water for animals, the drinker base comprising a substantially annular outer chamber configured to store water, a substantially annular middle chamber configured to store water, a substantially annular inner chamber configured to store water, a first set of threads for accepting a container device, the first set of threads disposed on an outer surface of the substantially annular middle chamber, a second set of threads disposed on an inner surface of the substantially annular middle chamber, a third set of threads disposed on an inner surface of the substantially annular inner chamber, a first port configured to transfer water between the substantially annular inner chamber to the substantially annular middle chamber; and a second port configured to transfer water between the substantially annular middle chamber substantially annular middle chamber to the substantially annular outer chamber.

In an embodiment of the disclosure, the drinker base is composed of plastic.

In an embodiment of the disclosure, the drinker based is composed of metal.

In an embodiment of the disclosure, the threads on the inside surface, the threads on the outer surface of the inner chamber and the threads in the outer surface of the middle chamber are configured to accept containers of water.

In an embodiment of the disclosure, the threads on the inner surface of the inner chamber are configured to accept a container of water with a bottle neck diameter comparable to a bottle neck diameter of a 750 ml container, such as a plastic soda bottle, known to one of skill in the art.

In an embodiment of the disclosure, the threads on the inner surface of the middle chamber are configured to accept a container of water with a bottle neck diameter comparable to a mason jar, known to one of skill in the art.

In an embodiment of the disclosure, the threads on the outer surface of the middle chamber are configured to accept a container of water with a bottle neck diameter comparable to a large drinking cup, known to one of skill in the art.

In an embodiment of the disclosure, the drinker base is configured to provide water to small animals, such as ducklings, chicks, quail and other small farm poultry, cats, small dogs, and other domestic animals.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a drinker base according to the disclosure.

FIG. 2 is a planar view of the top of a drinker base according to the disclosure.

FIG. 3 is a planar view of the bottom of a drinker base according to the disclosure.

FIG. 4 is a side view of the drinker base according to the disclosure.

FIG. 5 is a cross section of the drinker base according to the disclosure.

### DETAILED DESCRIPTION OF THE PREFERRED EMBODIMENTS

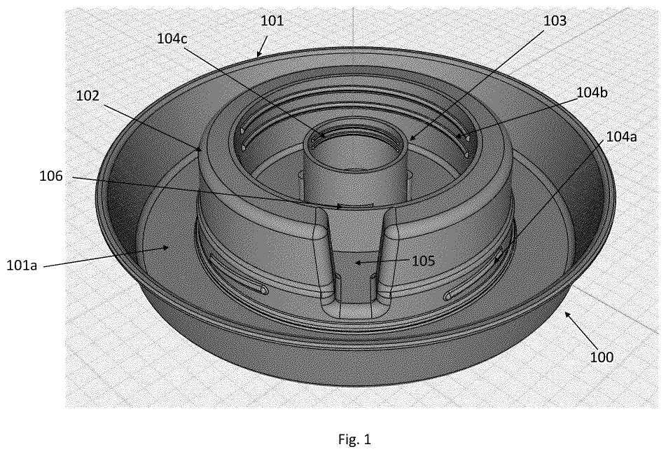

FIG. 1 is a perspective view of a drinker base for supplying water to animals according to the disclosure. The drinker base 100 comprises a substantially annular outer chamber enclosure 101. The drinker base 100 comprises a substantially annular outer chamber 101a configured to store water. The drinker base 100 comprises a substantially annular middle chamber 102 configured to store water. The drinker base 100 comprises a substantially annular inner chamber 103 configured to store water. The drinker base 100 comprises a first set of threads 104a for accepting a container device, where the first set of threads 104a are disposed on an outer surface of the substantially annular middle chamber 102. The drinker base 100 comprises a second set of threads 104b disposed on an inner surface of the substantially annular middle chamber 102. The drinker base 100 comprises a third set of threads 104c disposed on an inner surface of the substantially annular inner chamber. The drinker base 100 comprises a first port 106 configured to transfer water between the substantially annular inner chamber 103 to the substantially annular middle chamber 102. The drinker base 100 comprises a second port 105 configured to transfer water between the substantially annular middle chamber 102 substantially annular middle chamber to the substantially annular outer chamber 101.

In an embodiment of the disclosure, the threads on the inner surface of the inner chamber 104c are configured to accept a container of water with a bottle neck diameter comparable to a bottle neck diameter of a 750 ml container, such as a plastic soda bottle, known to one of skill in the art.

In an embodiment of the disclosure, the threads on the inner surface of the middle chamber 104b are configured to accept a container of water with a bottle neck diameter comparable to a mason jar, known to one of skill in the art.

In an embodiment of the disclosure, the threads on the outer surface of the middle chamber 104a are configured to accept a container of water with a bottle neck diameter comparable to a large drinking cup, known to one of skill in the art.

In an embodiment of the disclosure, the drinker base 100 is configured to provide water to small animals, such as ducklings, chicks, quail and other small farm poultry, cats, small dogs, and other domestic animals.

In an embodiment of the disclosure, the drinker base 100 may be composed of plastic, such as polypropylene or other suitable plastic materials known to one of skill in the art. The drinker base 100 may be manufactured in plastic by extruded plastic equipment, 3D additive printing technology or stereolithography. Other manufacturing methods known to one of skill in the art may be employed.

In an embodiment of the disclosure, the drinker base 100 may be composed of metal, such as stainless steel, aluminum, or other suitable metal materials known to one of skill in the art.

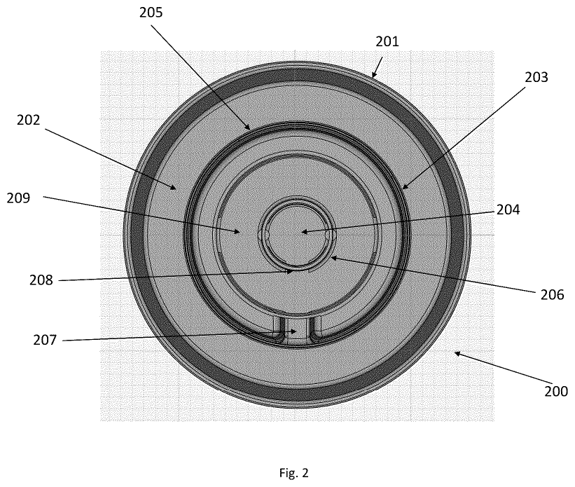

FIG. 2 is a planer view of the top of a drinker base 200 according to the disclosure. The drinker base 200 comprises a substantially annular outer chamber enclosure 201. The drinker base 200 comprises a substantially annular outer chamber 202 configured to store water. The drinker base 200 comprises a substantially annular middle chamber 209 configured to store water. The drinker base 200 comprises a substantially annular middle chamber enclosure 203. The drinker base 200 comprises a substantially annular inner chamber 204 configured to store water. The drinker base 200 comprises a substantially annular middle chamber enclosure 205.

The drinker base 200 comprises a first port 208 configured to transfer water between the substantially annular inner chamber 204 to the substantially annular middle chamber 209. The drinker base 200 comprises a second port 207 configured to transfer water between the substantially annular middle chamber 209 to the substantially annular outer chamber 202.

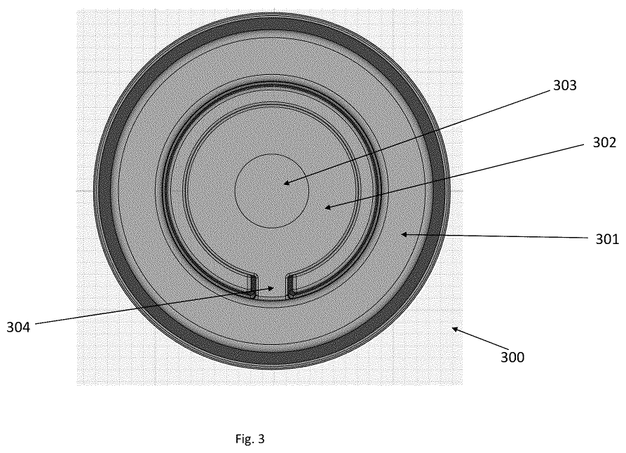

FIG. 3 is a planer view of the bottom of a drinker base according to the disclosure. The drinker base 300 comprises a substantially annular outer chamber 301 configured to store water. The drinker base 300 comprises a substantially annular middle chamber 302 configured to store water. The drinker base 300 comprises a substantially annular inner chamber 303 configured to store water.

In an embodiment shown in FIG. 3, the drinker base 300 comprises a port 304 configured to transfer water between the substantially annular middle chamber 302 to the substantially annular outer chamber 301.

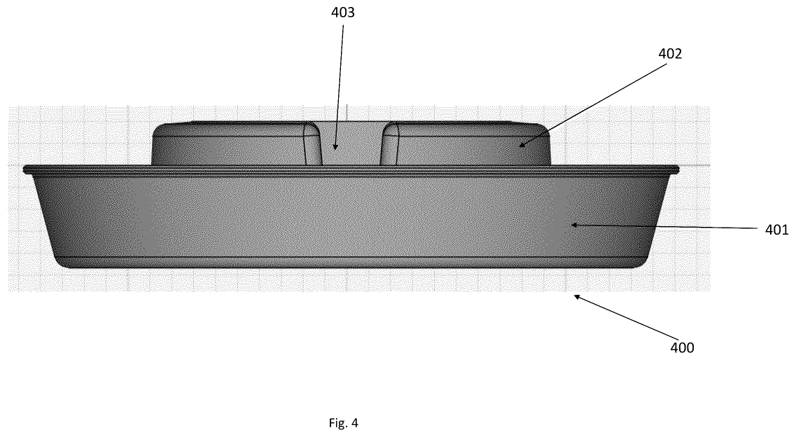

FIG. 4 is a side view of the drinker base according to the disclosure. The drinker base 400 comprises an outer surface 401 enclosing a middle chamber configured to store water (not shown in this view). The drinker base 400 comprises an outer surface 402 of a middle chamber configured to store water (not shown here). The drinker base 400 comprises a port 403 adapted to transfer water from the middle chamber of the drinker base 400 to the outer chamber of the drinker base 400.

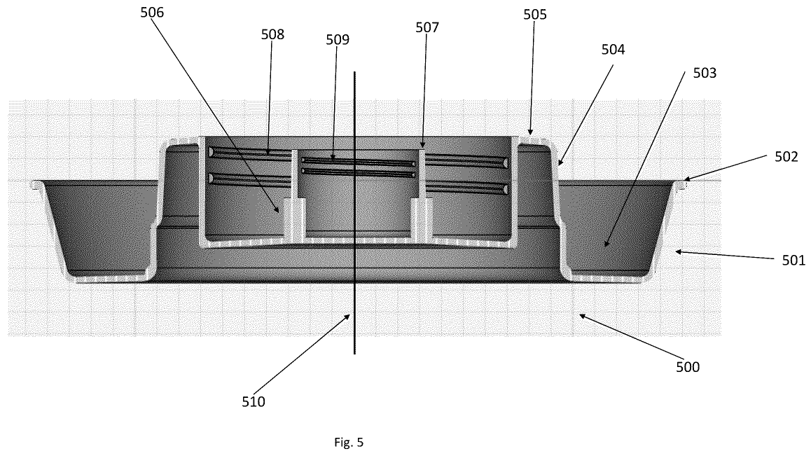

FIG. 5 is a cross section of the drinker base according to the disclosure. The drinker base 500 comprises a substantially annular outer enclosure 501. The drinker base 500 comprises a top surface 502 of the substantially annular outer enclosure 501. The drinker base 500 comprises a middle chamber 503 configured to store water. The drinker base 500 comprises a substantially annular middle chamber enclosure 504. The drinker base 500 comprises a substantially annular middle enclosure surface 505. The drinker base 500 comprises a substantially annular inner enclosure 506. The drinker base 500 comprises a substantially annular inner enclosure top surface 507. The drinker base 500 comprises a first set of threads 508. The drinker base 500 comprises a second set of threads 509, disposed on an inner surface of the middle chamber enclosure 504. The drinker base 500 comprises a second set of threads 509 disposed on the inner surface of the inner chamber disclosure 506. The drinker base 500 comprises a third set of threads (not shown in this view) disposed on the outer surface of the inner enclosure 506.

In an embodiment, the drinker base 500 is a surface of revolution around an axis of rotation 510.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A drinker base for supplying water for animals, comprising:
a substantially annular outer chamber configured to store water;
a substantially annular middle chamber configured to store water;
a substantially annular inner chamber configured to store water;
a first set of threads for accepting a container device, the first set of threads disposed on an outer surface of the substantially annular middle chamber;
a second set of threads disposed on an inner surface of the substantially annular middle chamber;
a third set of threads disposed on an inner surface of the substantially annular inner chamber;
a first port configured to transfer water between the substantially annular inner chamber to the substantially annular middle chamber; and
a second port configured to transfer water between the substantially annular middle chamber substantially annular middle chamber to the substantially annular outer chamber.

2. The drinker base according to claim 1, where the drinker base is composed of a plastic material.

3. The drinker base according to claim 2, where the plastic material is extruded polypropylene.

4. The drinker base according to claim 2, where the plastic material is formed by an additive 3D printer.

5. The drinker base according to claim 2, where the drinker base is formed by stereolithography.

6. The drinker base of claim 1, where the drinker base is composed of metal.

7. The drinker base of claim 6, where the metal material is stainless steel or aluminum.

8. The drinker base of claim 1, where the first set of threads is configured to receive a first container with a first neck diameter.

9. The drinker base according to claim 1, where the second set of threads is configured to receive a second container with a second neck diameter.

10. The drinker base according to claim 1, where the third set of threads is configured to receive a container with a third neck diameter.

11. The drinker base according to claim 1, where the drinker base is configured to supply water to small animals.

12. A drinker base for supplying water for animals, comprising:
an outer chamber configured to store water;
a middle chamber configured to store water;
an inner chamber configured to store water;
a first set of threads for accepting a container device, the first set of threads disposed on an outer surface of the middle chamber;
a second set of threads disposed on an inner surface of the middle chamber;
a third set of threads disposed on an inner surface of the substantially annular inner chamber;
a first port configured to transfer water between the inner chamber to the middle chamber; and
a second port configured to transfer water between the middle chamber to the outer chamber.

13. The drinker base according to claim 12, where the drinker base is composed of a plastic material.

14. The drinker base of claim 12, where the drinker base is composed of metal.

15. The drinker base of claim 12, where the metal material is stainless steel or aluminum.

16. The drinker base of claim 12, where the first set of threads is configured to receive a first container with a first neck diameter.

17. The drinker base according to claim 12, where the second set of threads is configured to receive a second container with a second neck diameter.

18. The drinker base according to claim 12, where the third set of threads is configured to receive a container with a third neck diameter.

19. The drinker base according to claim 12, where the drinker base is configured to supply water to small farm animals.

20. The drinker base according to claim 12, where the drinker base is configured to supply water to domestic animals.
